(19) United States
(12) Patent Application Publication
(10) Pub. No.: US 2021/0295431 A1
(43) Pub. Date: Sep. 23, 2021

(54) ASSET USAGE RIGHTS TOKEN FOR CONNECTED ECOSYSTEMS

(71) Applicant: VOLLINGER CORP, Albuquerque, NM (US)

(72) Inventors: Tram Minh Vo, Los Angeles, CA (US); Christopher Bardin Ballinger, Los Angeles, CA (US)

(73) Assignee: VOLLINGER CORP, Albuquerque, NM (US)

(21) Appl. No.: 17/205,764

(22) Filed: Mar. 18, 2021

Related U.S. Application Data
(60) Provisional application No. 62/991,807, filed on Mar. 19, 2020.

(51) Int. Cl. G06Q 40/04; G06Q 10/10; G06Q 20/36; G06Q 30/00; G06Q 20/38; G06Q 50/26; G06F 16/27; G05B 15/02; H04L 29/08

(52) U.S. Cl. CPC G06Q 40/04; G06Q 10/10; G06Q 20/3676; G06Q 30/018; G06Q 2240/00; G06Q 50/26; G06F 16/27; G05B 15/02; H04L 67/142; G06Q 20/389

(57) ABSTRACT

The present invention discloses an Asset Usage Rights Token for connected ecosystems. Asset usage rights represent the right to use something of value under specified contractual terms such as a section of road, a parking space, a right of way, airspace, a charging station, etc. These mobility and transportation asset usage rights backing AURTs guarantee a certain dollar amount of resource use, rather than a certain quantity of use which help facilitate the monetization of public goods like streets, parking space etc.

### CROSS-REFERENCE TO RELATED APPLICATIONS

The present application is a non-provisional application of U.S. Provisional Application No. 62/991,807, filed on Mar. 19, 2020, the entirety of which is incorporated herein by reference.

### FIELD OF INVENTION

The present invention relates to a block-chain based currency exchange system and, more specifically, to a system and method for facilitating the exchange of asset-usage-rights (AUR) based tokens.

### BACKGROUND OF THE INVENTION

Innovative technologies such as the Internet of Things (IoT), block-chain, artificial intelligence (AI), and data analytics have changed how we design our cities, our mobility, and other ecosystems, many cities across the globe are adopting approaches to reducing Greenhouse Gas (GHG) emissions at larger scales in response to the global climate change crisis and population growth.

As a result, there is now a greater momentum for innovation that will enable the transformation to smarter cities. Examples include increasing adoption and technology development in energy solutions, electric vehicles, and smart mobility applications. Smart cities utilize digital technologies and data to make better decisions to create more efficient, sustainable and responsive cities where the quality of life is improved.

An essential component of a smart city is connected and smart mobility. There exist many platforms that enable smart mobility ecosystems that feature smooth access to transportation services, multimodal trip coordination, peer-to-peer (P2P) mobility applications, data security and privacy, time and cost efficiency, pay per use mobility, new and cost-efficient demand management tools, simplified and secure data sharing, new resources for underserved populations as well as targeted incentives to discourage congestion, carbon emissions and etc.

Enabling these technologies in an efficient and seamless method in a connected ecosystem calls for an innovative payment system. Traditional methods of collecting asset-usage-fees in applications such as “fast pass” are outdated and inefficient. Monetizing the usage of most mobility and transportation assets such as urban streets, airspace rights for drones or special right of ways for fast lanes directly and/or individually was either infeasible or impossible to implement efficiently with conventional methods.

An issued patent, U.S. Pat. No, 7,100,199B2, assigned to Intertrust Technologies Corp, discloses systems and techniques for secure transaction management and protecting rights of various participants in electronic commerce and other electronic or electronically-facilitated transactions. The prior art ensure that information is accessed in authorized ways, and maintains the integrity, availability, and/or confidentiality transactions in the presence of a central authority that regulates the transactions, thereby increasing the time taken for facilitating transactions and reducing the transparency of the transactions.

Another patent reference, U.S. Patent Pub. No. 2019/0068365A,1 assigned to nChain Holdings Ltd., provides a solution for the secure control and transfer or exchange of an asset via a block-chain. The prior art allows interaction between number of service providers and users on the block-chain platform. However, the service providers and their services disclosed in the prior art may not be validated before getting registered on the block-chain platform.

Thus, to facilitate the transition to a smart and sustainable mobility transportation ecosystem and to overcome the drawbacks of the prior arts mentioned above, a novel approach by creating a connected mobility marketplace through an AURT stablecoin, an asset-usage-rights based payment system is required.

The mobility and transportation asset usage rights backing AURTs guarantees a certain dollar amount of resource use, rather than a certain quantity of use, i.e., a dollar's worth of parking at its current price, rather than a certain amount of parking time or space. In contrast, asset backed tokens guarantee the holder a certain amount of the asset, typically by physical delivery.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, a continuing need exists for a new and improved system for facilitating the exchange of AURT tokens.

### SUMMARY OF THE INVENTION

AURT is a unique block-chain based stable token backed by asset-usage-rights designed to be utilized within connected ecosystems such as smart mobility and transportation. The AURT token is unique in its backing by asset-usage-rights, which result in a token which is both stable (i.e., suitable as a medium of exchange) and efficient (i.e., the cost of stabilizing the token is very low relative to other proposed tokens backed by precious commodities or financial assets). The AURT is not backed by a fiat currency, an asset, a basket of assets, a basket of currencies, or a basket of commodities. These mobility and transportation asset usage rights backing AURTs guarantee a certain dollar amount of resource use, rather than a certain quantity of use. AURT allows direct charging of marginal cost and makes the cost of services, such as mobility, more transparent, efficient, and fair/equitable for all stakeholders. This approach facilitates the monetization of public goods like streets, and enables charging for negative externalities such as carbon emissions. Stability against the national/local currency also enables the dynamic pricing of resources in smart cities.

AURT tokens, combined with secure, digital identities (a set of validated attributes and credentials for the digital world) allow recording of a “trusted trip,” are an essential component in monetizing connected mobility. This provides for a unique linking, within a permissioned blockchain network, of: (1) the AURT, which is itself intrinsically linked to mobility infrastructure assets, (2) the location of the vehicle from its on board telematics using 5G+ and enhanced global positioning system (GPS)/fixed base triangulation, and (3) the World Wide Web Consortium (W3C) compliant vehicle identification (ID). The process enables mobility asset-usage-providers and other smart city innovations to design novel use cases. This concept enables a seamless payment system for connected ecosystems and creates a connected marketplace including a number of asset usage rights providers and asset usage rights consumers. AURT based payment system incorporates dynamic pricing to incentivize sustainable/green behavior and real time demand management as well as other incentives. The value of asset usage rights may differ depending on location, day and/or time of use, demand, congestion factors and other circumstances. To account for the change in price, the platform uses a dynamic pricing approach to determine the prices of mobility services against the AURT in real-time.

The AURT token aims to launch on a private block-chain where foundation members who meet requirements can run permission nodes and act as validators for the transactions. The platform subjects all transactions to a minimal transaction fee in order to maintain the network and to incentivize the permission nodes to validate the transactions.

A validating body is responsible for the governing and associated risks as well as managing an AUR Registry for storing assets-usage-rights services. AURT tokens are minted once verified asset owners contribute asset-usage-rights to the platform. The asset-usage-rights are denoted in the national currency (e.g., USD, EUR) and each AURT is one-to-one backed by one unit of asset-usage-right. When the on-boarding of asset-usage-rights is complete which includes registering of the asset-usage-rights on the AUR registry, the corresponding amount of tokens is minted against the asset-usage-rights simultaneously via a smart contract.

The newly minted tokens are recorded on the asset-usage-provider's ledger account. Technically, smart contracts on the block-chain can create an unlimited number of tokens against an unlimited number of assets. In practice, the supply is limited by the number of asset-usage-rights that are added to the ecosystem. Once tokens are available, users can then request them in exchange for fiat money. AURT tokens can be integrated with any smart and connected platform to enable an easy-to-use, single means of seamless payment. Verified users on such platforms can request AURT tokens by exchanging fiat money.

Once any amount of tokens has been spent in exchange for using a service, the block-chain automatically transfers AURTs to the asset-usage-provider's wallet through the execution of a smart contract, the asset-usage-provider can choose to redeem the corresponding fiat money, where tokens are returned to the platform and burnt as the fiat is deposited to the user's conventional fiat account via the digital wallet.

The AURT platform incorporates three different ledgers running on two block-chains to operate the ecosystem in a secure, efficient and resilient structure. The AURT token incorporates cutting edge methods to capture the data accurately. For example, a user's mobility asset usage is verified through the connected mobility ecosystem with the digital-vehicle-identity (MOBI VID) which is itself registered on a digital ledger.

Other objectives and aspects of the invention will become apparent from the following detailed description, taken in conjunction with the accompanying drawings, which illustrate, by way for example, the features in accordance with embodiments of the invention. For example, present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions cause one or more processors to perform the resulting operations.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF DRAWINGS

The objects, features and advantages of the present invention will be apparent from the following detailed descriptions of the various aspects of the invention in conjunction with reference to the following drawings, where:

FIG. 1 illustrates a block-chain based asset-usage-right (AURT) platform in accordance with an embodiment of the present invention;

FIG. 2 illustrates an AUR module within the asset-usage-right (AURT) platform in accordance with an embodiment of the present invention;

FIG. 3A illustrates minting of one or more AURT tokens in the AUR module in accordance with an embodiment of the present invention;

FIG. 3B illustrates burning of one or more AURT tokens in the AUR module in accordance with an embodiment of the present invention;

FIG. 4 illustrates a method for providing asset-usage-right (AURT) services in a marketplace in accordance with an embodiment of the present invention;

FIG. 5 is a block diagram depicting the components of a system according to various embodiments of the present invention; and

FIG. 6 is an illustration of a computer program product embodying an aspect of the present invention.

### DETAILED DESCRIPTION

As noted above, the present invention relates to a system and a method for facilitating the exchange of asset-usage-rights (AUR) based tokens. AURT is a unique block-chain-based token backed by asset-usage-rights designed to be utilized within connected ecosystems such as smart mobility and transportation. The assets could be anything the owner/operator/provider would like to tokenize, such as parking usage rights, EV charging usage rights, road/bridge usage rights, mobility/transit data, urban airspace, access rights to green zones and carbon emission rights and other types of pollution admission rights.

The AURT token is unique in its backing by asset-usage-rights, as it is not backed by fiat currency, an asset, a basket of assets, a basket of currencies, or a basket of commodities. Asset usage rights represent the right to use something of value under specified contractual terms such as a section of road, a parking space, a right of way, airspace, a charging station, etc. These mobility and transportation asset usage rights backing AURTs guarantee a certain dollar amount of resource use, rather than a certain quantity of use, i.e., a dollar's worth of parking at its current price, rather than a certain amount of parking time or space.

Tokenizing any ecosystem asset-usage-rights via leveraging block-chain technology unlocks the value of assets in a novel way previously undoable with traditional approaches. Asset-usage-rights are related to infrastructure, services, and real assets such as land (ownership), which are relatively stable assets, as are municipal revenue and bonds backed by assets and usage fees. Past attempts to create stable means of payment relied on credible monetary government rules, or backing by precious commodities. It is notable that while there is a high cost to holding reserves of precious commodities used to back stable money, the opportunity cost of AURs are essentially zero, making the AURT of the present disclosure a uniquely efficient way of backing and stabilizing the token value.

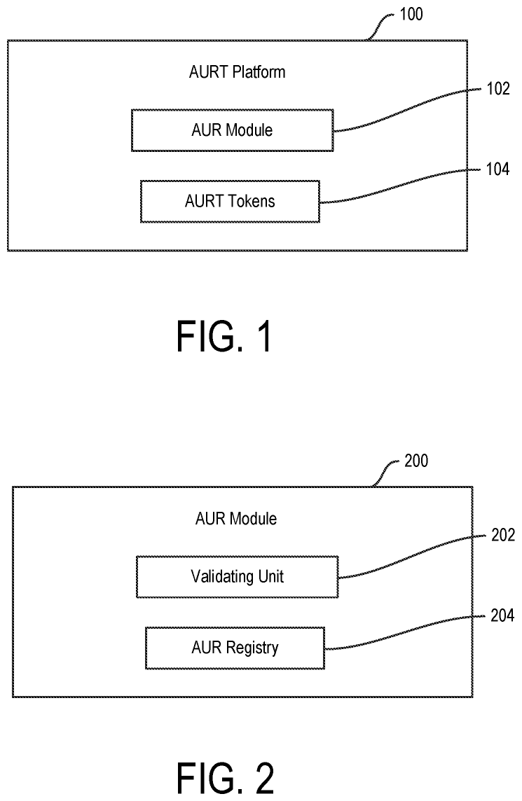

FIG. 1 illustrates a block-chain based asset-usage-right (AURT) platform 100. The AURT platform 100 consists of multiple nodes that form a marketplace. The two essential components of the marketplace that interact with each other are assets-usage-rights service providers and assets-usage-rights users. Block-chain-based tokenized asset-usage-rights have the potential to disrupt the mobility marketplace and create a more transparent, secure, resilient and equitable mobility ecosystem for stakeholders. The AURT token, in this ecosystem, bridges mobility users, providers, and smart cities while facilitating management of mobility services. The AURT based payment system incorporates dynamic pricing to incentivize sustainable/green behavior and real time demand management as well as other incentives.

The service providers on the AURT platform 100 are required to register themselves first to provide services to the users. The assets-usage-rights services provided by the service providers could include anything the service providers would like to tokenize, such as parking usage rights, EV charging usage rights, road/bridge usage rights, mobility/transit data, urban airspace, access rights to green zones and carbon emission rights and other types of pollution admission rights. The value of asset usage rights may differ depending on location, day and/or time of use, demand, congestion factors and other circumstances.

The AURT platform 100 includes an AUR module 102 consisting of a validating unit for validating the assets-usage-rights provided by the service providers and stores one or more validated service providers. The validating unit can be referred to as the Foundation herein. The AUR module 100 further consists of an AUR registry that maintains asset-usage-rights provided by the one or more validated service providers. The validating unit referred to as the Foundation is responsible for governing the service providers and their associated services and associated risks as well as managing the AUR Registry. The Foundation conducts the due diligence to verify the eligibility and admission of the assets-usage-rights that the service provider wants to contribute within the standard frameworks of jurisdiction. The Foundation may introduce novel use cases for the AURT token as user adoption, smart city, mobility, and other adjacent ecosystems connectivity increase.

A smart contract responsible for generation and issuance of AUR tokens 104 is integrated within the platform 100. The AUR tokens 104 are based on the asset-usage-rights services offered by validated service providers wherein the AURT tokens 104 are credited in a wallet of the one or more validated service providers. A number of users transacting with the validated service providers exist on the platform 100 in form of nodes. The users exchange a fiat currency against the AURT tokens 104 generated by the smart contract to access the asset-usage-rights services from the validated service providers. The fiat money is fully held in reserve by a trusted bank (chosen by the Foundation), and invested in bank deposits or highly rated securities, until the corresponding AURT is spent or redeemed. The Foundation complies with applicable local or regional regulations regarding the handling of fiat money.

When a user requests tokens 104 via fiat money, the platform 100 returns the corresponding amount of tokens 104 equal to the value of asset usage in the national currency to the user's digital wallet via a smart contract. AURTs are exchanged from one public-key-address to the next, until they are annihilated by a user or an asset usage rights provider. Following the same logic, when a user wishes to redeem their fiat money, they return their tokens 104 to the platform 100. The corresponding fiat money is deposited to the user's conventional fiat account via the digital wallet and the AURT tokens 104 are burnt and removed from supply via a smart contract.

Once any amount of tokens 104 has been spent in exchange for using a service, the block-chain automatically transfers AURTs to the asset-usage-provider's wallet through the execution of the smart contract. Then, the service provider can choose to redeem the corresponding fiat money, where tokens 104 are returned to the platform 100 and burnt as the fiat is deposited to the user's conventional fiat account via the digital wallet. Consequently, the tokens 104 are removed from supply as the asset-usage-rights are consumed and stability of AURT is maintained.

Alternatively, an asset-usage-rights provider can choose to spend their tokens 104 on another service offered on the platform 100. If an asset-usage-rights provider decides to withdraw a certain amount of asset-usage-rights from the platform 100, then the algorithm burns the corresponding amount of AURTs. This is done by sending the tokens 104 to the terminal public key without a private key, therefore no exchange of fiat currency takes place (since no initial fiat money was deposited by the provider).

The AURT platform 100 incorporates three different ledgers running on two block-chains to operate the ecosystem in a secure, efficient and resilient structure; assets Ledger, lifecycle ledger and a tracking ledger. The assets ledger runs on the first block-chain. It tracks the minting and burning of the AURT tokens 104 against the asset-usage-rights Rights (AUR) Registry.

The lifecycle ledger also runs on the first block-chain to verify the minting/creation, transfer to users and vice versa as well as the burning of the AURT tokens 104. The tracking ledger runs on the second block-chain and tracks all AURT transactions between users (digital mobility wallets) and asset usage rights providers, which requires a higher throughput: higher transactions per second (TPS).

The AURT token incorporates cutting edge methods to capture the data accurately. For example, a user's mobility asset usage is verified through the connected mobility ecosystem with the digital-vehicle-identity which is itself registered on a digital ledger. The platform 100 via an app may determine the GPS data, vehicle and infrastructure IoT sensors, etc. to record the “trusted trip” and input the amount of mobility asset usage data.

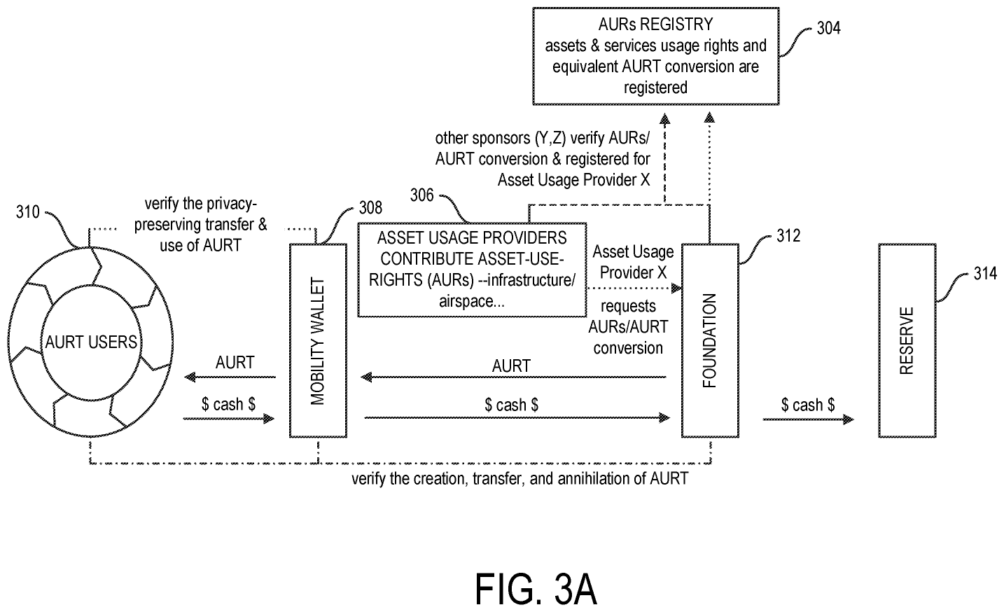

FIG. 2 illustrates an AUR module within the asset-usage-right (AURT) platform in accordance with the present invention. The AUR module 200 within the AURT platform incorporates a validating unit 202 (referred to as the Foundation) for validating the services provided by a number of service providers registered on the AURT platform and an AUR registry 204 for registering the validated services provided by the different service providers on the AURT platform.

The Foundation conducts the due diligence to verify the eligibility and admission of the assets-usage-rights that the asset-usage-provider wants to contribute within the standard frameworks of jurisdiction. The on-boarding process for each asset-usage-right may or may not require qualified third-party verification such as verification from the department of transportation in the relevant jurisdiction.

When the on-boarding of asset-usage-rights is complete by the Foundation i.e. registration of the asset-usage-rights on the Asset-Usage-Rights Registry 204, the corresponding amount of tokens are minted against the asset-usage-rights simultaneously via a smart contract. Then, the newly minted tokens are recorded on the asset-usage-provider's ledger account.

Technically, smart contracts on the block-chain can create an unlimited number of tokens against an unlimited number of assets. In practice, the supply is limited by the number of asset-usage-rights that are added to the ecosystem. Once tokens are available, users can then request them in exchange for fiat money. Firstly, a maximum token holding limit may be enforced on every user's digital wallet, which limits the amount of tokens that a user can hold. The wallet limit is determined by the Foundation or the validating unit 202 and may be changed if it is found to be inadequate for asset-usage-rights transactions.

The AURT platform incorporates three different ledgers running on two block-chains to operate the ecosystem in a secure, efficient and resilient structure; assets Ledger, lifecycle ledger and a tracking ledger. The assets ledger runs on the first block-chain. It tracks the minting and burning of the AURT tokens against the asset-usage-rights contributed by sponsors/service providers and maintains the Asset Usage Rights (AUR) Registry 204.

The lifecycle ledger also runs on the first block-chain to verify the minting/creation, transfer to users and vice versa as well as the burning of the AURT tokens. The tracking ledger runs on the second block-chain and tracks all AURT transactions between users (digital mobility wallets) and asset usage rights providers, which requires a higher throughput: higher transactions per second (TPS).

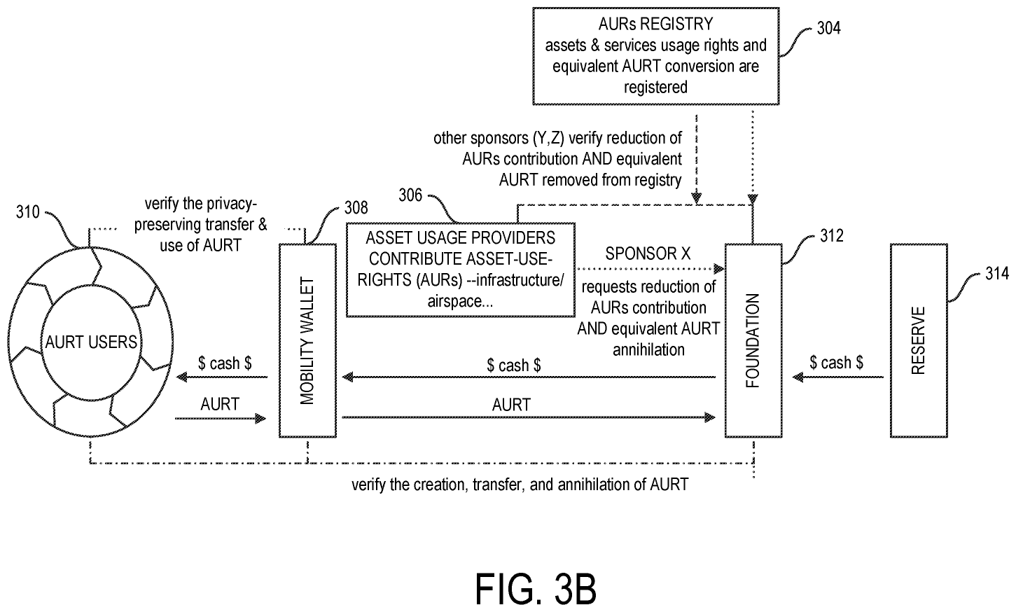

FIG. 3A illustrates minting of one or more AURT tokens in the AUR module in accordance with the present invention. AURT tokens can be integrated with any smart and connected platform to enable an easy-to-use, single means of seamless payment. Verified users 310 on such platforms can request AURT tokens by exchanging fiat money.

Users 310 need to have a conventional fiat account with a commercial bank and a digital wallet 308 ready to accept AURTs to perform transactions on the platform. They can spend tokens to pay for services and goods, send tokens to or trade with other users 310 in a smart mobility ecosystem via a user-friendly application. When a user requests tokens via fiat money, the platform returns the corresponding amount of tokens equal to the value of asset usage in the national currency to the user's digital wallet 308 via a smart contract.

After being minted, AURTs are exchanged from one public-key-address to the next, until they are annihilated by a user or an asset usage rights provider. The fiat money is fully held in reserve 314 by a trusted bank which is chosen by the Foundation 312, and invested in bank deposits or highly rated securities, until the corresponding AURT is spent or redeemed. Users 310 are able to redeem their fiat backing fully (minus the transaction fee) at any given time in exchange for tokens.

In the event of an unexpected market crash or a malicious attack to the system, a temporary shutdown will serve as a safety mechanism and users 310 will be able to redeem their fiat at a fixed rate. The Foundation 312 complies with applicable local and/or regional regulations regarding the handling of fiat money. To ensure transparency, the AURT token is audited by a qualified auditing firm in the respective jurisdiction.

While the platform enables users 310 to trade tokens with marginal arbitrage opportunities for greater ease of use and functionality, several incentive mechanisms are in place to prevent the tokens from being utilized as an investment or held for profit. Firstly, a maximum token holding limit is enforced on every user's digital wallet 308, which limits the amount of tokens that a user can hold. The wallet limit is determined by the Foundation 312 and may be changed if it is found to be inadequate for asset-usage-rights transactions.

Users 310 exchange cash for AURT to make payments for assets and services from other users 310 in the AURT platform. AURT tokens are issued in exchange for fiat payments and makes fiat payments in exchange for AUR tokens. Tokens are minted once verified asset owners contribute asset-usage-rights to the platform. The asset-usage-rights are denoted in the national currency (e.g., USD, EUR) and each AURT is one-to-one backed by one unit of asset-usage-right. When the on-boarding of asset-usage-rights in the AUR registry 304 is complete, the corresponding amount of tokens is minted against the asset-usage-rights simultaneously via a smart contract.

Then, the newly minted tokens are recorded on the asset-usage-providers' 306 ledger account. Technically, smart contracts on the block-chain can create an unlimited number of tokens against an unlimited number of assets. In practice, the supply is limited by the number of asset-usage-rights that are added to the ecosystem. Once tokens are available, users 310 can then request them in exchange for fiat money.

FIG. 3B illustrates burning of one or more AURT tokens in the AUR module in accordance with the present invention. Once any amount of tokens has been spent in exchange for using a service, the block-chain based AURT platform automatically transfers AURT tokens to the service provider's wallet 308 through the execution of a smart contract.

Then, the asset-usage-provider 306 can choose to redeem the corresponding fiat money, where tokens are returned to the platform and burnt as the fiat money is deposited to the user's conventional fiat account via the digital wallet 308. Consequently, the tokens are removed from supply as the asset-usage-rights are consumed and stability of AURT is maintained.

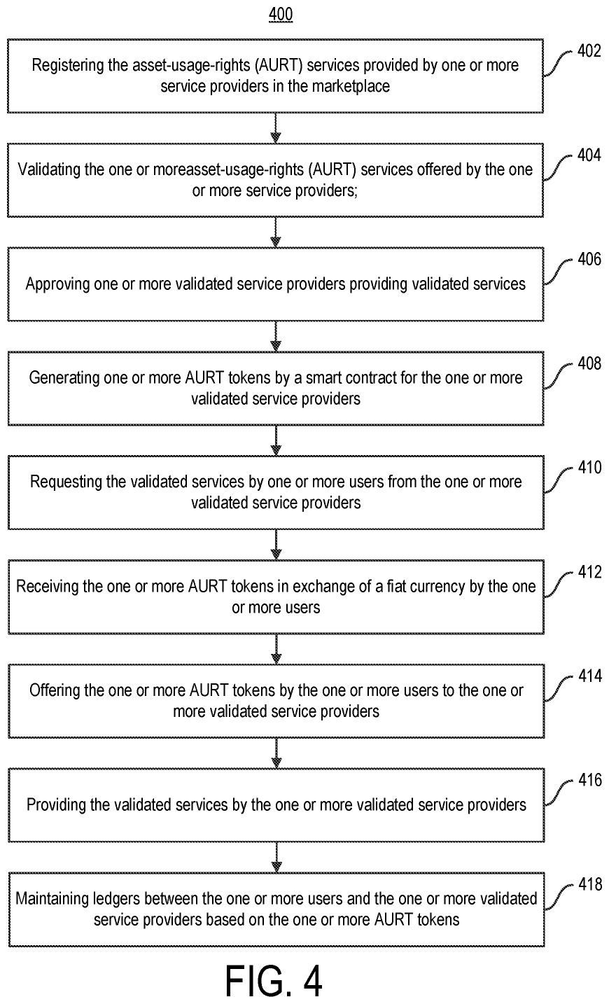

FIG. 4 illustrates a method for providing asset-usage-right (AURT) services in a marketplace in accordance with the present invention. The flowchart 400 illustrates a method including registration of the asset-usage-rights (AURT) services provided by one or more service providers in the marketplace 402. Next, one or more asset-usage-rights (AURT) services offered by the one or more service providers are validated by the Foundation which is the validating body 404.

After validation of the one or more asset-usage-rights (AURT) services, the one or more asset-usage-rights (AURT) services are approved in step 406. In the next step, one or more AURT tokens for the one or more validated service providers are generated by the smart contract 408. Multiple users then request for the validated services from the one or more validated service providers in step 410.

The users receive the one or more AURT tokens in exchange of a fiat currency in step 412. The one or more AURT tokens are offered to the service providers against the services provided by the validated service providers in step 414. After the AURT tokens are received by the validated service providers, the service providers provide the services to the users in step 416. Finally, multiple ledgers including the assets ledger, the lifecycle ledger and the tracking ledger are maintained between the one or more users and the one or more validated service providers based on the one or more AURT tokens generated on the AURT platform in step 418.

As noted above, the invention according to various embodiments can be implemented in a system with one or more processor(s), as a computer program product, or a computer implemented method. Thus, the invention also includes all of the hardware, and/or software as may be necessary to implement the process as described herein.

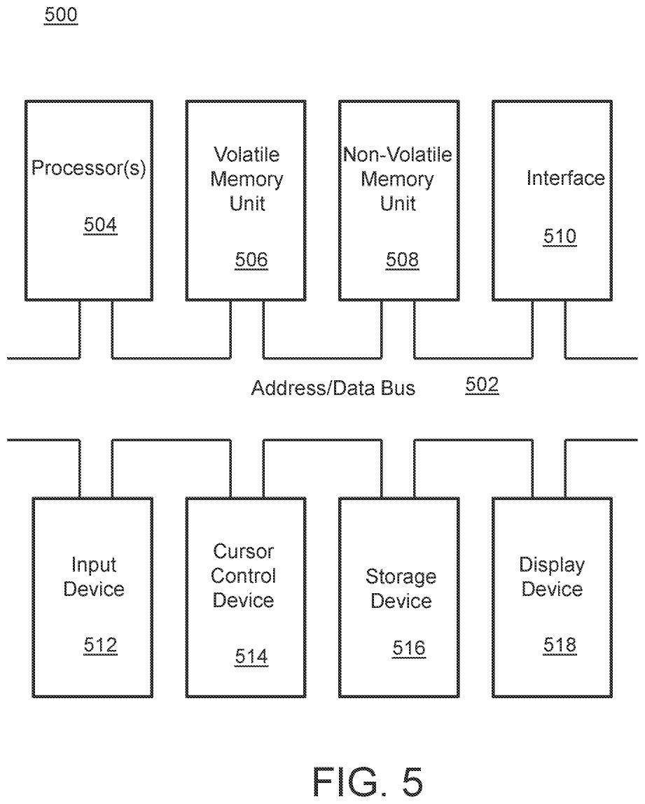

For example, a block diagram depicting an example of a system (i.e., computer system 500) of the present invention in accordance with various embodiments is provided in FIG. 5. The computer system 500 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 500. When executed, the instructions cause the computer system 500 to perform specific actions and exhibit specific behavior, such as described herein. In various aspects, the computer system 500 can be embodied in any device(s) that operates to perform the functions as described herein as applicable to the particular application, such as a desktop computer, a mobile or smart phone, a tablet computer, a computer embodied in a mobile platform, or any other device or devices that can individually and/or collectively execute the instructions to perform the related operations/processes.

The computer system 500 may include an address/data bus 502 that is configured to communicate information. Additionally, one or more data processing units, such as a processor 504 (or processors), are coupled with the address/data bus 502. The processor 504 is configured to process information and instructions. In an aspect, the processor 504 is a microprocessor. Alternatively, the processor 504 may be a different type of processor such as a parallel processor, application-specific integrated circuit (ASIC), programmable logic array (PLA), complex programmable logic device (CPLD), or a field programmable gate array (FPGA) or any other processing component operable for performing the relevant operations.

The computer system 500 is configured to utilize one or more data storage units. The computer system 500 may include a volatile memory unit 506 (e.g., random access memory (“RAM”), static RAM, dynamic RAM, etc.) coupled with the address/data bus 502, wherein a volatile memory unit 506 is configured to store information and instructions for the processor 504. The computer system 500 further may include a non-volatile memory unit 508 (e.g., read-only memory (“ROM”), programmable ROM (“PROM”), erasable programmable ROM (“EPROM”), electrically erasable programmable ROM “EEPROM”), flash memory, etc.) coupled with the address/data bus 502, wherein the non-volatile memory unit 508 is configured to store static information and instructions for the processor 504. Alternatively, the computer system 500 may execute instructions retrieved from an online data storage unit such as in “Cloud” computing. In an aspect, the computer system 500 also may include one or more interfaces, such as an interface 550, coupled with the address/data bus 502. The one or more interfaces are configured to enable the computer system 500 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology. Further, one or more processors 504 can be associated with one or more associated memories, where each associated memory is a non-transitory computer-readable medium. Each associated memory can be associated with a single processor 504 (or device), or a network of interacting processors 504 (or devices), such as a network of vehicles or other components using the AURs.

In one aspect, the computer system 500 may include an input device 512 coupled with the address/data bus 502, wherein the input device 512 is configured to communicate information and command selections to the processor 504. In accordance with one aspect, the input device 512 is an alphanumeric input device, such as a keyboard, that may include alphanumeric and/or function keys. Alternatively, the input device 512 may be an input device other than an alphanumeric input device. In an aspect, the computer system 500 may include a cursor control device 514 coupled with the address/data bus 502, wherein the cursor control device 514 is configured to communicate user input information and/or command selections to the processor 504. In an aspect, the cursor control device 514 is implemented using a device such as a mouse, a track-ball, a track-pad, an optical tracking device, or a touch screen. The foregoing notwithstanding, in an aspect, the cursor control device 514 is directed and/or activated via input from the input device 512, such as in response to the use of special keys and key sequence commands associated with the input device 512. In an alternative aspect, the cursor control device 514 is configured to be directed or guided by voice commands.

In an aspect, the computer system 500 further may include one or more optional computer usable data storage devices, such as a storage device 516, coupled with the address/data bus 502. The storage device 516 is configured to store information and/or computer executable instructions. In one aspect, the storage device 516 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 518 is coupled with the address/data bus 502, wherein the display device 518 is configured to display video and/or graphics. In an aspect, the display device 518 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 500 presented herein is an example computing environment in accordance with an aspect. However, the non-limiting example of the computer system 500 is not strictly limited to being a computer system. For example, an aspect provides that the computer system 500 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

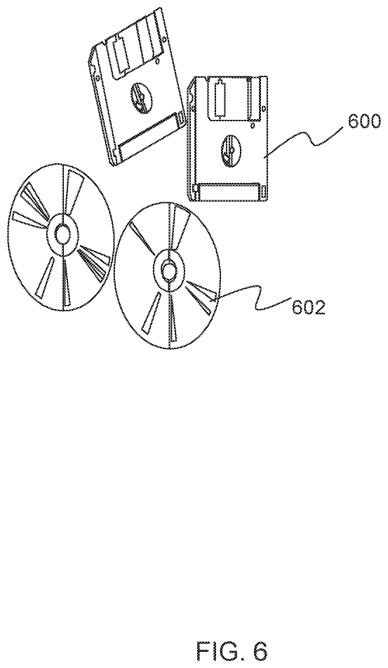

An illustrative diagram of a computer program product (i.e., storage device) embodying the present invention is depicted in FIG. 6. The computer program product is depicted as floppy disk 600 or an optical disk 602 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

While the various embodiments of the present invention have been described above, it should be understood that they have been presented by way of example only, and not of limitation. Likewise, the figure may depict an example architectural or other configuration for the invention, which is done to aid in understanding the features and functionality that can be included in the invention. The invention is not restricted to the illustrated example architectures or configurations, but the desired features can be implemented using a variety of alternative architecture and configurations.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

What is claimed is:

1. A block-chain based asset-usage-right (AURT) platform, the AURT platform comprising:
an AUR module, the AUR module comprising:
a validating unit, the validating unit operable for validating assets-usage-rights as provided by one or more service providers and storing one or more validated service providers;
an AUR registry, the AUR registry operable for maintaining asset-usage-rights provided by the one or more validated service providers; and
one or more AURT tokens generated by a smart contract, wherein the one or more AURT tokens are based on the asset-usage-rights services offered by the one or more validated service providers, and wherein the one or more AURT tokens are credited in a wallet of the one or more validated service providers, and wherein one or more users exchanges a fiat currency against the one or more AURT tokens to access the one or more asset-usage-rights services, such that upon accessing the one or more asset-usage-rights services, the one or more AURT tokens are deducted from the wallet of the one or more validated service providers.

2. The block-chain based asset-usage-right (AURT) platform in accordance with claim 1, wherein the services provided by the one or more service providers include one or more of access rights to green zones, pollution emission rights, carbon emission rights, parking access rights, road access rights, bridge access rights and urban air space usage rights.

3. The block-chain based asset-usage-right (AURT) platform in accordance with claim 1, wherein value of the one or more asset-usage-rights services varies based on one or more of demand, time of use and geographical location.

4. The block-chain based asset-usage-right (AURT) platform in accordance with claim 1, wherein the AURT platform includes an assets ledger, a lifecycle ledger and a tracking ledger.

5. The block-chain based asset-usage-right (AURT) platform in accordance with claim 4, wherein the assets ledger records generation and usage of the one or more AURT tokens.

6. The block-chain based asset-usage-right (AURT) platform in accordance with claim 4, wherein the lifecycle ledger verifies generation and usage of the one or more AURT tokens.

7. The block-chain based asset-usage-right (AURT) platform in accordance with claim 4, wherein the tracking ledger tracks crediting of the one or more AURT tokens from the one or more users to the one or more service providers.

8. The block-chain based asset-usage-right (AURT) platform in accordance with claim 1, wherein the validating unit limits the one or more AURT tokens held by the one or more users and the one or more service providers.

9. The block-chain based asset-usage-right (AURT) platform in accordance with claim 8, wherein the limits defined by the validating unit can be changed by the validating unit.

10. A block-chain based method for providing asset-usage-right (AURT) services in a marketplace, the block-chain based method comprising an act of:
causing one or more processers to execute instructions encoded on a non-transitory computer-readable medium, such that upon execution, the one or more processors perform operations of:
registering the asset-usage-rights (AURT) services provided by one or more service providers in the marketplace;
validating the one or moreasset-usage-rights (AURT) services offered by the one or more service providers;
approving one or more validated service providers providing validated services from the one or more asset-usage-rights services on an AUR registry;
generating one or more AURT tokens by a smart contract for the one or more validated service providers;
requesting the validated services by one or more users from the one or more validated service providers;
receiving the one or more AURT tokens in exchange of a fiat currency by the one or more users;
offering the one or more AURT tokens by the one or more users to the one or more validated service providers for accessing the validating services;
providing the validated services by the one or more validated service providers to the one or more users in exchange of the one or more AURT tokens; and
maintaining ledgers between the one or more users and the one or more validated service providers based on the one or more AURT tokens.

11. A computer program product for providing block-chain based asset-usage-right (AURT) services in a marketplace, the computer program product comprising:
a non-transitory computer-readable medium having executable instructions encoded thereon, such that upon execution of the instructions by one or more processors, the one or more processors perform operations of:
registering the asset-usage-rights (AURT) services provided by one or more service providers in the marketplace;
validating the one or moreasset-usage-rights (AURT) services offered by the one or more service providers;
approving one or more validated service providers providing validated services from the one or more asset-usage-rights services on an AUR registry;
generating one or more AURT tokens by a smart contract for the one or more validated service providers;
requesting the validated services by one or more users from the one or more validated service providers;
receiving the one or more AURT tokens in exchange of a fiat currency by the one or more users;
offering the one or more AURT tokens by the one or more users to the one or more validated service providers for accessing the validating services;
providing the validated services by the one or more validated service providers to the one or more users in exchange of the one or more AURT tokens; and
maintaining ledgers between the one or more users and the one or more validated service providers based on the one or more AURT tokens.
